(19) United States
(12) Patent Application Publication
(10) Pub. No.: US 2025/0130894 A1
(43) Pub. Date: Apr. 24, 2025

(54) DYNAMICALLY ENABLING FOREGROUND SCANS OF MEMORY BLOCKS

(71) Applicant: Micron Technology, Inc., Boise, ID (US)

(72) Inventors: Lei Lin, Fremont, CA (US); Guang Hu, Mountain View, CA (US); Chun Sum Yeung, San Jose, CA (US); Dongxiang Liao, Cupertino, CA (US); Xiangang Luo, Fremont, CA (US)

(21) Appl. No.: 18/776,314

(22) Filed: Jul. 18, 2024

Related U.S. Application Data
(60) Provisional application No. 63/544,860, filed on Oct. 19, 2023.

(51) Int. Cl. G06F 11/10

(52) U.S. Cl. CPC G06F 11/1048; G06F 11/1068

(57) ABSTRACT

Various embodiments provide for dynamically enabling and disabling foreground scans of blocks of a memory device, which can be part of a memory sub-system. For instance, some embodiments provide an improved methodology for triggering foreground media scans of blocks of a memory device without disturbing a maximum idea time of background media scans of blocks of the memory device.

### PRIORITY APPLICATION

This application claims the benefit of priority to U.S. Provisional Application Ser. No. 63/544,860, filed Oct. 19, 2023, which is incorporated herein by reference in its entirety

### TECHNICAL FIELD

Example embodiments of the disclosure relate generally to memory devices and, more specifically, to dynamically enabling and disabling foreground scans of blocks of a memory device, which can be part of a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is a block diagram illustrating an example computing system that includes a memory sub-system, in accordance with some embodiments of the present disclosure.

FIGS. 2A and 2B illustrate a flow diagram of an example method for dynamically enabling and disabling foreground scans of blocks of a memory device, in accordance with some embodiments of the present disclosure.

FIGS. 3 through 5 are diagrams illustrating example schedules for dynamically enabling and disabling foreground media scans, in accordance with some embodiments of the present disclosure.

FIG. 6 is a block diagram of an example computer system in which embodiments of the present disclosure may operate.

### DETAILED DESCRIPTION

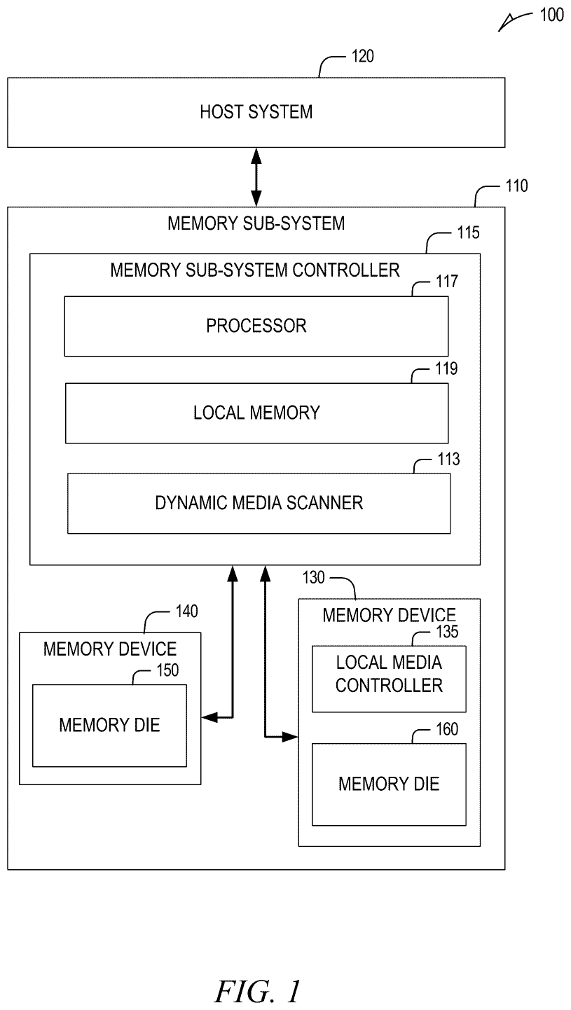

Aspects of the present disclosure are directed to dynamically enabling and disabling foreground scans of blocks of a memory device, which can be part of a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can send access requests to the memory sub-system, such as to store data at the memory sub-system and to read data from the memory sub-system.

The host system can send access requests (e.g., write commands, read commands) to the memory sub-system, such as to store data on a memory device at the memory sub-system, read data from the memory device on the memory sub-system, or write/read constructs with respect to a memory device on the memory sub-system. The data to be read or written, as specified by a host request (e.g., data access request or command request), is hereinafter referred to as “host data.” A host request can include logical address information (e.g., logical block address (LBA), namespace) for the host data, which is the location the host system associates with the host data. The logical address information (e.g., LBA, namespace) can be part of metadata for the host data. Metadata can also include error handling data (e.g., error-correcting code (ECC) codeword, parity code), data version (e.g., used to distinguish age of data written), valid bitmap (which LBAs or logical transfer units contain valid data), and so forth.

The memory sub-system can initiate media management operations, such as a write operation on host data that is stored on a memory device or a scan (e.g., media scan) of one or more blocks of a memory device. For example, firmware of the memory sub-system can re-write previously written host data from a location of a memory device to a new location as part of garbage collection management operations. The data that is re-written, for example as initiated by the firmware, is hereinafter referred to as “garbage collection data.”

“User data” hereinafter generally refers to host data and garbage collection data. “System data” hereinafter refers to data that is created and/or maintained by the memory sub-system for performing operations in response to host requests and for media management. Examples of system data include, and are not limited to, system tables (e.g., logical-to-physical memory address mapping table (also referred to herein as a L2P table), data from logging, scratch pad data, and so forth).

A memory device can be a non-volatile memory device. A non-volatile memory device is a package of one or more die. Each die can comprise one or more planes. For some types of non-volatile memory devices (e.g., NOT-AND (NAND)-type devices), each plane comprises a set of physical blocks. For some memory devices, blocks are the smallest area that can be erased. Each block comprises a set of pages. Each page comprises a set of memory cells, which store bits of data. The memory devices can be raw memory devices (e.g., NAND), which are managed externally, for example, by an external controller. The memory devices can be managed memory devices (e.g., managed NAND), which are raw memory devices combined with a local embedded controller for memory management within the same memory device package.

Certain memory devices, such as NAND-type memory devices, comprise one or more blocks, (e.g., multiple blocks) with each of those blocks comprising multiple memory cells. For instance, a memory device can comprise multiple pages (also referred as wordlines), with each page comprising a subset of memory cells of the memory device. A memory device can comprise one or more cache blocks and one or more non-cache blocks, where data written to the memory device is first written to one or more cache blocks, which can facilitate faster write performance; data stored on the cache blocks can eventually be moved (e.g., copied) to one or more non-cache blocks at another time (e.g., performing a block compaction operation at a time when the memory device is idle), which can facilitate higher storage capacity on the memory device. A cache block can comprise a single-level cell (SLC) block that comprises multiple SLCs, and a non-cache block can comprise a multi-level cell (MLC) block that comprises multiple MLCs, a triple-level cell (TLC) block that comprise multiple TLCs, or a quad-level cell (QLC) block that comprises QLCs. Writing first to one or more SLCs blocks can be referred to as SLC write caching. Generally, writing data to such memory devices involves programming (by way of a program operation) the memory devices at the page level of a block, and erasing data from such memory devices involves erasing the memory devices at the block level (e.g., page level erasure of data is not possible).

In conventional memory systems (e.g., memory sub-systems), there are multiple mechanisms that are either time-drive or workload-driven, which can cause the state of the data stored in a NAND-type memory device (e.g., stored in blocks thereof) to degrade. If the degradation is not dealt with (especially with respect to efficacy and urgency), degradation can result in increased Bit Error Count (BEC) and eventually data loss (e.g., uncorrectable Error Correction Code (UECC) error). To address data degradation, a media scan (MS) (also referred to herein as a scan) is performed on one or more blocks of a NAND-type memory device to ensure that the one or more blocks meet certain system-specific requirements, such as power-off data retention, Latent Read Disturb (LRD), cross-temperature, and the like, which can all potentially affect the integrity of data stored on the one or more blocks.

For certain memory technologies, such as Replacement Gate (RG) NAND-type memory devices, media scan algorithms usually perform scans in the foreground (FG) and background (BG) at a regular cadence. Typically, scan operations are not blocked from being performed on a NAND-type memory device by any other operations on the NAND-type memory device, except for states in which the NAND-type memory device is powered off. As a result, performing a foreground media scan too often can negatively impact host operation performance, as host operations will be suspended in favor of the foreground media scan as the foreground media scan steps in at a certain cadence. Not performing a foreground media scan frequently enough can risk the integrity of stored data on the NAND-type memory device.

Accordingly, it is a challenge to optimize the tradeoff between performance (e.g., host data operation) of the NAND-type memory device and the integrity of stored data on the NAND-type memory device when performing foreground and background media scans. If foreground media scans are disabled, background media scans may not be able to scan all blocks (e.g., that need a scan) within a predetermined period of time (predetermined time period) and maintaining data integrity on the NAND-type memory device can be a challenge. If foreground media scans are enabled, host operation performance on the NAND-type memory device can degrade when foreground media scans are triggered frequently and the idle time for background media scans may not be fully utilized.

Various embodiments described herein address deficiencies of conventional memory block scanning methodologies. In particular, various embodiments provide for dynamically enabling and disabling foreground scans of blocks of a memory device, which can be part of a memory sub-system. For instance, some embodiments provide an improved methodology for triggering foreground media scans (or foreground scans) of blocks of a memory device without disturbing a maximum idea time of background media scans (or background scans) of blocks of the memory device.

According to some embodiments, a media scan (or scan) of a plurality of blocks (e.g., all available blocks) of a memory device is performed according to a media scan schedule, where the schedule comprises a (media scan) time period (e.g., 30 hours) that defines a time over which scanning of all of the plurality of blocks is to be completed, and where the time period is divided (e.g., uniformly or non-uniformly, such as randomly) into a series of time intervals or cycles (e.g., 10 intervals/cycles). During the time period, background scans can be used as first-priority scans (e.g., executed during every idle time), and foreground scans can be used as second-priority scans (e.g., selectively used during certain time intervals), with the foreground scans being skipped for/during one or more time intervals based on overall scan progress over the time period. The overall scan progress can be monitored by checking the overall scan progress at or near the end of each time interval, or at or near the end of certain time intervals. The overall scan progress can be used as a judgment on whether foreground scans are to be enabled for (e.g., used during) one or more subsequent time intervals. Various embodiments enable a memory system to dynamically adjust foreground media skip time and cadence to avoid enabling foreground scans too early or too late.

As used herein, a scan cadence (or cadence) of a foreground media scan comprises a cadence at which the foreground media scan is triggered during a time span (e.g., time interval). When a foreground media scan is triggered during a time span (e.g., based on a fixed cadence or a dynamically-determined/adjusted cadence), one or more host operations performed during the time span can be interrupted (e.g., cannot resume until the triggered foreground media scan ends) or one or more host operations can be prevented from being performed during the time span (e.g., until the triggered foreground media scan ends).

The use of various embodiment by a memory system (e.g., memory sub-system) can reduce triggering/execution of foreground media scans of blocks of a memory device (of the memory system), which in turn can improve performance (e.g., host data performance) of the memory system. Further, various embodiments can reduce triggering/execution of foreground media scans of blocks of the memory device while ensuring that the integrity of data stored in the blocks is maintained (e.g., by using a dynamic mix of background media scans and foreground media scans to ensure media scan of all blocks is performed over a certain time period). An embodiment described herein can be applied to various types of memory systems, such as a managed NAND and SSD, to better use foreground media scans with reduced performance and reliability penalties.

As used herein, a foreground media scan (or foreground scan) can comprise a media scan process that when performed (on one or more blocks or pages of a memory device) causes one or more host operations to be preempted or prevented from being performed. As used herein, a background media scan (or background scan) can comprise a media scan process that when performed (on one or more blocks or pages of a memory device) does not cause one or more host operations to be preempted and does not prevent one or more host operations from being performed. A background media scan can be performed (on one or more blocks or pages of a memory device) during idle periods of a memory sub-system, such as when host operations are not being performed on one or more blocks or pages of a memory device. As used herein, a host operation can comprise a data write operation or data read operation being performed on one or more blocks or pages of a memory device in response to a request (e.g., write request or read request) received (e.g., by a memory sub-system) from a host system.

Disclosed herein are some examples of dynamically enabling and disabling foreground scans of blocks of a memory device, as described herein.

FIG. 1 illustrates an example computing system 100 that includes a memory sub-system 110, in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory devices 130, 140 when the memory sub-system 110 is coupled with the host system 120 by the PCIe or CXL interface. The physical host interface can provide an interface for passing control, address, data, and other signals between the memory sub-system 110 and the host system 120.

FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random-access memory (DRAM) and synchronous dynamic random-access memory (SDRAM).

Some examples of non-volatile memory devices (e.g., memory device 130) include a NAND type flash memory and write-in-place memory, such as a three-dimensional (3D) cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional (2D) NAND and 3D NAND.

Each of the memory devices 130 can include one or more arrays of memory cells. One type of memory cell, for example, SLCs, can store one bit per cell. Other types of memory cells, such as MLCs, TLCs, QLCs, and penta-level cells (PLCs), can store multiple or fractional bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks. As used herein, a block comprising SLCs can be referred to as a SLC block, a block comprising MLCs can be referred to as a MLC block, a block comprising TLCs can be referred to as a TLC block, and a block comprising QLCs can be referred to as a QLC block.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or another suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands, requests, or operations from the host system 120 and can convert the commands, requests, or operations into instructions or appropriate commands to achieve the desired access to the memory devices 130 and/or the memory device 140. The memory sub-system controller 115 can be responsible for other operations such as wear leveling operations, garbage collection operations, error detection and ECC operations, encryption operations, caching operations, and address translations between a logical address (e.g., LBA, namespace) and a physical memory address (e.g., physical block address) that are associated with the memory devices 130. The memory sub-system controller 115 can further include host interface circuitry to communicate with the host system 120 via the physical host interface. The host interface circuitry can convert the commands received from the host system 120 into command instructions to access the memory devices 130 and/or the memory device 140 as well as convert responses associated with the memory devices 130 and/or the memory device 140 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local media controller 135) for media management within the same memory device package. An example of a managed memory device is a managed NAND (MNAND) device.

Each of the memory devices 130, 140 include a memory die 150, 160. For some embodiments, each of the memory devices 130, 140 represents a memory device that comprises a printed circuit board, upon which its respective memory die 150, 160 is solder mounted.

The memory sub-system controller 115 includes a dynamic media scanner 113 that enables or facilitates the memory sub-system controller 115 to dynamically enable and disable foreground scans of blocks of one or more of the memory devices 130, 140 as described herein. Some or all of the dynamic media scanner 113 is included by the local media controller 135, thereby enabling the local media controller 135 to dynamically enable and disable foreground scans of blocks of the memory device 130 as described herein.

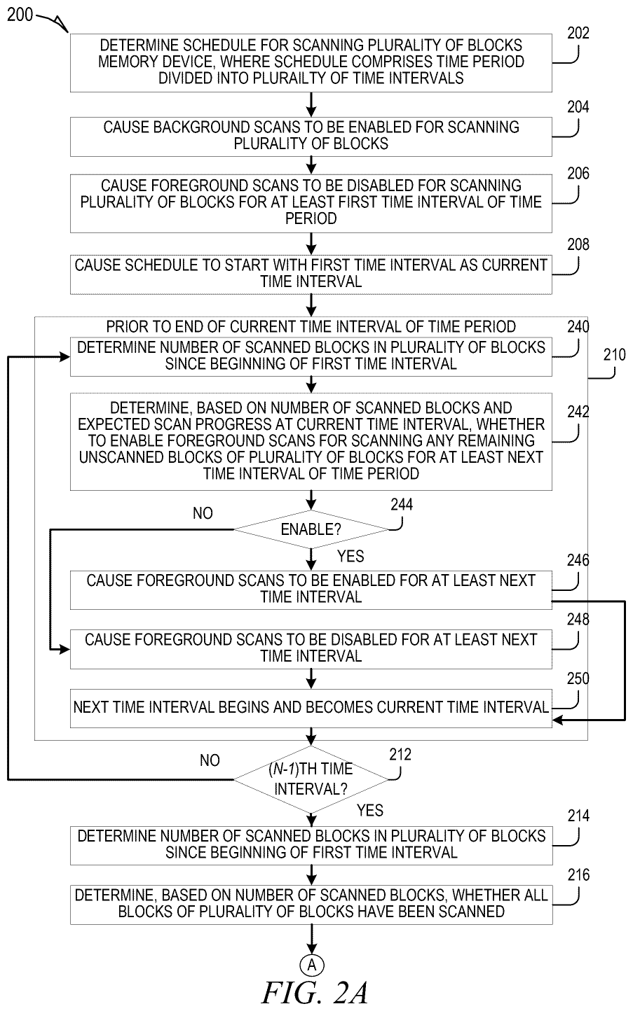

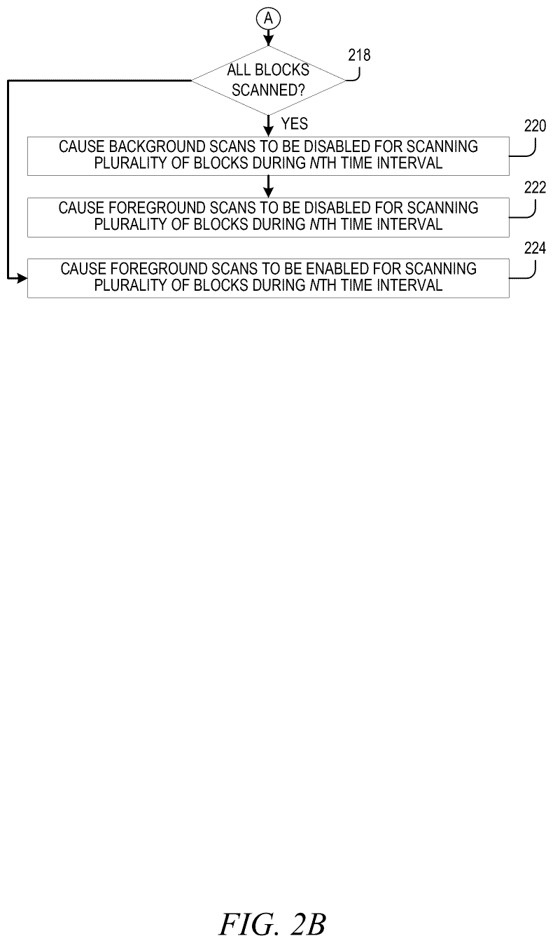

FIGS. 2A and 2B illustrate a flow diagram of an example method 200 for dynamically enabling and disabling foreground scans of blocks of a memory device (e.g., of a memory sub-system), in accordance with some embodiments of the present disclosure. Method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, method 200 is performed by the memory sub-system controller 115 of FIG. 1 based on the dynamic media scanner 113. Additionally, or alternatively, for some embodiments, method 200 is performed, at least in part, by the local media controller 135 of the memory device 130 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are used in every embodiment. Other process flows are possible.

Referring now to method 200 of FIG. 2A, at operation 202, a processing device (e.g., the processor 117 of the memory sub-system controller 115) determines a schedule for scanning a plurality of blocks of a memory device (e.g., 130, 140), where the schedule comprises a time period (e.g., 24 hours or 30 hours) that is divided into a set of time intervals, which can form a series of time intervals (e.g., divided into 10 time intervals) that span the time period. For instance, the time period can be divided into a series of N time intervals (e.g., where N=10). Depending on the embodiment, the value N can be determined by a user (e.g., of a memory sub-system), a manufacturer (e.g., of the memory sub-system), or a process (e.g., automatic process that executes periodically and adjusts the value N between time periods). Depending on the embodiment, the time period can be divided uniformly and, as such, each time interval of the series of time intervals can have a uniform time span. Alternatively, at least two time intervals of the series of time intervals can have a different time span. For instance, the time period can be divided non-uniformly (e.g., such that each time interval has a randomly-determined time span), which can result in at least two time intervals of the series of time intervals having different time spans.

At operation 204, the processing device (e.g., the processor 117) causes background scans to be enabled for scanning the plurality of blocks. Additionally, at operation 206, the processing device causes foreground scans to be disabled (e.g., skipped) for scanning the plurality of blocks for at least a first time interval of the time period. Eventually, at operation 208, the processing device causes the schedule to start with the first time interval as the current time interval. During the first time interval, a background scan of one or more blocks of the plurality of blocks can be performed during each idle time (e.g., when the other foreground operations, such as user data reads and writes are not being performed with respect to the memory device). According to some embodiments, at the beginning of the schedule, all blocks of the plurality of blocks can be considered unscanned for the (current) time period, and need to be scanned by the end of the time period.

During operation 210, and prior to the current time interval ending, the processing device (e.g., the processor 117) performs one or more of operations 240 through 250. At operation 240, the processing device determines a number of scanned blocks in the plurality of blocks since a beginning of the first time interval (e.g., the beginning of the time period). Based on the number of scanned blocks (as determined by operation 240) and based on an expected scan progress at (or near) the end of the current time interval, at operation 242, the processing device determines, whether to enable foreground scans for scanning any remaining unscanned blocks of the plurality of blocks for at least a next (e.g., second) time interval of the time period (where the next time interval follows the current time interval). Depending on the embodiment, the expected scan progress at (or near) the end of the current time interval can be determined by the number of the current time interval. For instance, the expected scan progress at (or near) the end of the current time interval can comprise a percentage of a total number of blocks to be scanned, where the percentage can be determined by the number of the current time interval, or (e.g., where the time intervals are not uniform) the percentage can be determined based on the amount of time left until the end of the time period or the amount of time left until the beginning of the last time interval (e.g., end of the (N-1)th time interval). For instance, where the time period is uniformly divided by a value N=10 (resulting in 10 uniform time intervals), the expected scan progress at (or near) the end of first time interval can be 10% of all blocks being scanned, the expected scan progress at (or near) the end of second time interval can be 20% of all blocks being scanned, and so on. Additionally, for some embodiments, the expected scan progress at (or near) the end of the second-to-last time interval (e.g., (N-1)th time interval) can be set to 100% to ensure that both foreground scans and background scans are enabled and available for use during the last time interval (e.g., Nth time interval) to complete the scan of all blocks by the end of the time period. According to some embodiments, this feature is implemented by decision point 212 and operations 214 through 224, as illustrated in FIGS. 2A and 2B and described herein.

At decision point 244, if it is determined that the foreground scans should be enabled for scanning any remaining unscanned blocks of the plurality of blocks for at least the next (e.g., second) time interval, method 200 proceeds to operation 246. If however at decision point 244, it is determined that the foreground scans should not be enabled for scanning any remaining unscanned blocks of the plurality of blocks for at least the next (e.g., second) time interval, method 200 proceeds to operation 248.

At operation 246, the processing device (e.g., the processor 117) causes the foreground scans to be enabled for at least the next (e.g., second) time interval. For some embodiments, operation 246 comprises enabling the foreground scans to be performed with a fixed scan cadence during the next time interval (e.g., where the foreground scan is triggered during the next time interval at a fixed cadence). Alternatively, for some embodiments, operation 246 comprises determining a difference between the number of scanned blocks and the expected scan progress at the end of the first time interval, determining a scan cadence (e.g., dynamically-determined/adjusted scan cadence) based on the difference, and thereafter enabling the foreground scans to be performed with the (determined) scan cadence during the second time interval. Depending on the embodiment, determining the scan cadence based on the difference can comprise identifying the scan cadence in a predetermined look-up table based on the difference (e.g., where the predetermined look-up table facilitates mapping the difference to the scan cadence). The predetermined look-up table can be one generated by a manufacturer and can be one generated based on experimentation and testing. Alternatively, determining the scan cadence based on the difference can comprise calculating the scan cadence based on the difference and a cadence formula (e.g., cadence function based on the difference).

After operation 246, method 200 proceeds to operation 250, where the next (e.g., second) time interval begins, the next (e.g., second) time interval becomes the current time interval, and the method proceeds to decision point 212.

At operation 248, the processing device (e.g., the processor 117) causes the foreground scans to be disabled (e.g., skipped) for at least the next time interval. After operation 248, method 200 proceeds to operation 250, where the next (e.g., second) time interval begins, the next (e.g., second) time interval becomes the current time interval, and the method proceeds to decision point 212.

At decision point 212, if it is determined that the current time interval is the (N-1)th time interval of the time period (which represents the second-to-last time interval), method 200 proceeds to operation 214, otherwise method 200 returns to operation 240.

During the (N-1)th time interval, at operation 214, the processing device (e.g., the processor 117) determines (e.g., redetermines or updates) the number of scanned blocks in the plurality of blocks since the beginning of the first time interval. Based on the number of scanned blocks (as determined by operation 214), at operation 216, the processing device determines whether all blocks of the plurality of blocks have been scanned. Referring now to FIG. 2B, after operation 216, method 200 proceeds to decision point 218. At decision point 218, if it is determined that all blocks have been scanned, method 200 proceeds to operation 220, otherwise method 200 proceeds to operation 224.

At operation 220, the processing device (e.g., the processor 117) causes the background scans to be disabled (e.g., skipped) for an Nth time interval of the time period (which represents the last time interval of the time period) Thereafter, at operation 222, the processing device causes the foreground scans to be disabled (e.g., skipped) for the Nth time interval.

For operation 224, the processing device (e.g., the processor 117) causes the foreground scans to be enabled for the Nth time interval. As a result, both the foreground scans and the background scans would be enabled for the Nth time interval.

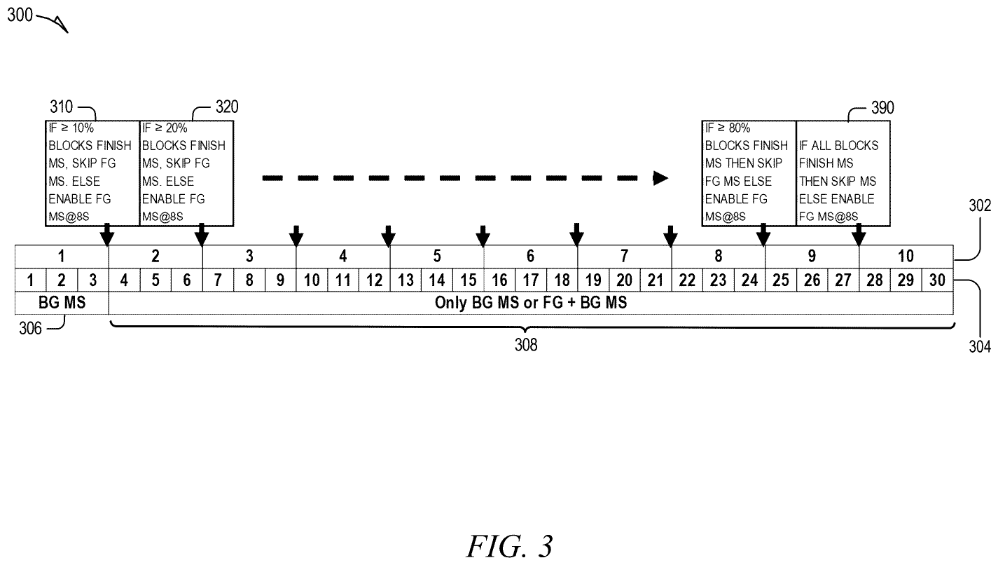

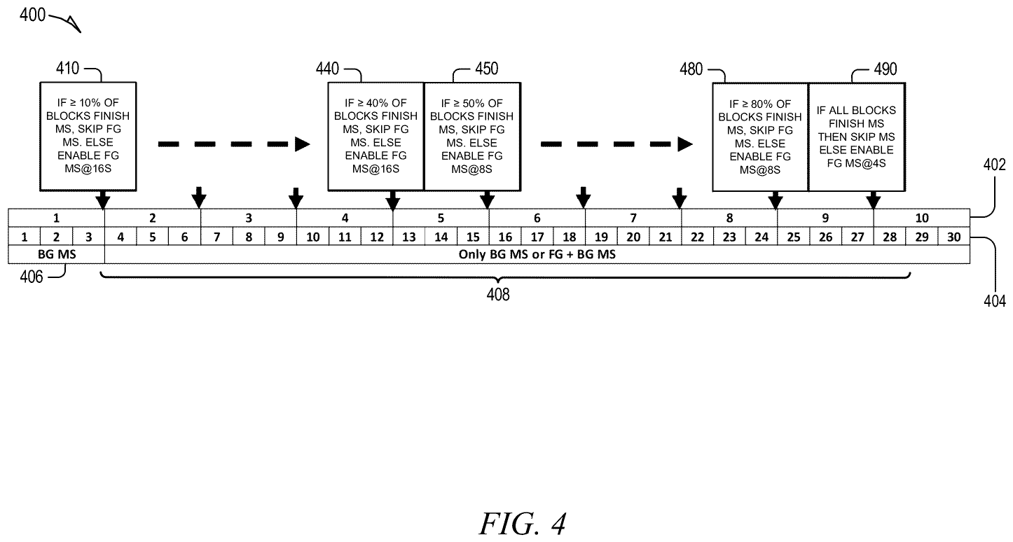

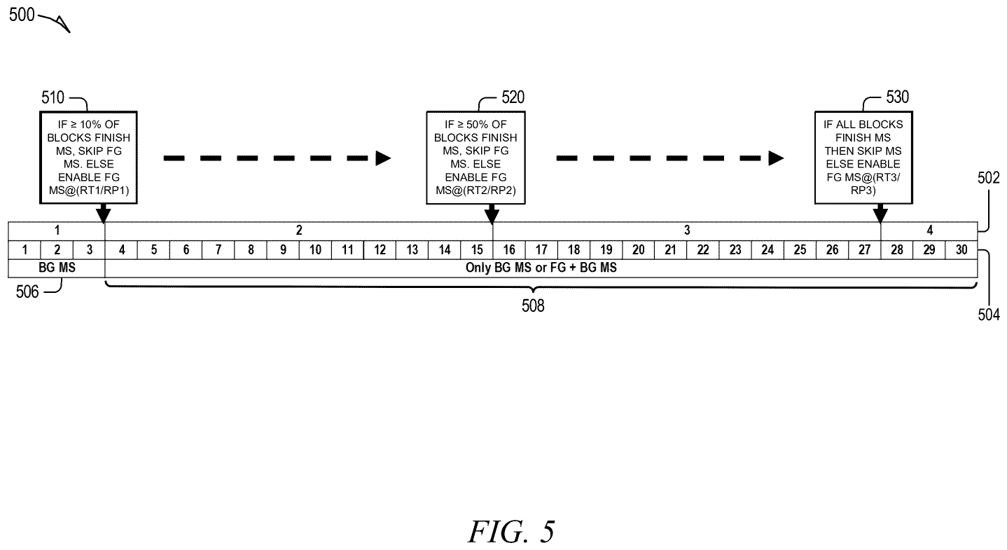

FIGS. 3 through 5 are diagrams illustrating example schedules for dynamically enabling and disabling foreground media scans, in accordance with some embodiments of the present disclosure. In particular, a time period of the example schedule 300 of FIG. 3 comprises uniform time intervals and the foreground scan is performed with a fixed scan cadence. A time period of the example schedule 400 of FIG. 4 comprises uniform time intervals and the foreground scan is performed with a dynamic scan cadence (e.g., dynamically-determined/adjusted cadence). A time period of the example schedule 400 of FIG. 4 comprises uniform time intervals and the foreground scan is performed with a dynamic scan cadence (e.g., dynamically-determined/adjusted cadence between different time intervals). A time period of the example schedule 500 of FIG. 5 comprises non-uniform time intervals and the foreground scan is performed with a dynamic scan cadence.

Referring now to the schedule 300 of FIG. 3, the schedule 300 comprises a time period 304 (e.g., one cycle period T) having a time span of 30 units of time. Depending on the embodiment, each unit of time (time unit) can be any measure of time, such as an hour, minute, or seconds. As shown, the time period 304 (e.g., T) is uniformly divided by a value N=10, thereby dividing the time period into 10 consecutive sections (or time intervals) and resulting in a series of time intervals (302) 1 through 10. During time interval 1 (306), foreground scans are disabled (e.g., skipped) and only background scans are enabled. After time interval 1 (306), foreground scans can be dynamically enabled and disabled for one or more of time intervals 2 through 10 (308). At or near the end of time interval 1 (e.g., right before entering time interval 2), the current progress of scanned blocks (e.g., how many of the total number of blocks have been scanned thus far) is determined or checked and the current progress is compared against an expected progress (310) for time interval 1. For some embodiment, if the current progress (number of scanned blocks thus far) is less than the expected progress, then foreground scans are enabled at least for time interval 2. If, however, at least equal to or greater than the expected progress, then foreground scans can be enabled at least for time interval 2. For various embodiments, the expected progress at or near the end of a time interval K is ≥(1/K*100) % of the total blocks to be scanned (at the start of the schedule 300). Accordingly, if at or near the end of time interval 1 the number of scanned blocks is ≥10% of the total blocks to be scanned (at the start of the schedule 300), then foreground scans are disabled (e.g., skipped) at least for time interval 2, otherwise foreground scans are enabled at least for time interval 2. If and when foreground scans are enabled during any time interval of the schedule 300, the foreground scans are enabled with a fixed cadence of (e.g., 8 seconds). Thereafter, at or near the end of time interval 2 (e.g., right before entering time interval 3), the current progress of scanned blocks (e.g., how many of the total number of blocks have been scanned thus far) is redetermined or re-checked and the current progress is compared against an expected progress (320) for time interval 2. Again, if at or near the end of time interval two, the number of scanned blocks is ≥20% of the total blocks to be scanned (at the start of the schedule 300), then foreground scans are disabled (e.g., skipped) at least for time interval 3, otherwise foreground scans are enabled at least for time interval 3. This continues for each of time intervals 3 through 8 of the schedule 300.

Eventually, at or near the end of time interval 9 (e.g., right before entering time interval 10), it is determined whether all blocks (to be scanned) have been scanned (390). If yes, then both background scans and foreground scans are disabled for time interval 10 (which represents the last time interval), otherwise both background scans and foreground scans are enabled at least for time interval 10. Again, if foreground scans are enabled for time interval 10, the foreground scans are enabled with a fixed cadence of (e.g., 8 seconds).

Referring now to the schedule 400 of FIG. 4, the schedule 400 is similar to the schedule 300 of FIG. 3, but foreground scans are enabled with a dynamically-determined (e.g., calculated) cadence. In particular, the schedule 400 comprises a time period 404 (e.g., one cycle period T) having a time span of 30 units of time. As described herein, each unit of time (time unit) can be any measure of time, such as an hour, minute, or seconds. As shown, the time period 404 (e.g., T) is uniformly divided by a value N=10, thereby dividing the time period into 10 consecutive sections (or time intervals) and resulting in a series of time intervals (402) 1 through 10. During time interval 1 (406), foreground scans are disabled (e.g., skipped) and only background scans are enabled. After time interval 1 (406), foreground scans can be dynamically enabled and disabled for one or more of time intervals 2 through 10 (408). At or near the end of time interval 1 (e.g., right before entering time interval 2), the current progress of scanned blocks (e.g., how many of the total number of blocks have been scanned thus far) is determined or checked and the current progress is compared against an expected progress (410) for time interval 1. For some embodiment, if the current progress (number of scanned blocks thus far) is less than the expected progress, then a cadence is determined (e.g., as shown, 16 seconds) based on a difference between the current progress and the expected difference, and foreground scans are enabled at least for time interval 2 with the determined cadence (foreground scans will be triggered according to the determined cadence). If, however, at least equal to or greater than the expected progress, then foreground scans can be enabled at least for time interval 2. For various embodiments, the expected progress at or near the end of a time interval K is ≥(1/K*100) % of the total blocks to be scanned (at the start of the schedule 400). Accordingly, if at or near the end of time interval 1 the number of scanned blocks is ≥10% of the total blocks to be scanned (at the start of the schedule 400), then foreground scans are disabled (e.g., skipped) at least for time interval 2. However, if at or near the end of time interval 1 the number of scanned blocks is not ≥10% of the total blocks to be scanned (at the start of the schedule 400), then a cadence is determined based on a difference between the number of blocks scanned thus far and 10% of the total blocks to be scanned (e.g., cadence determined based on a difference look-up-table), and foreground scans are enabled at least for time interval 2 with the determined cadence (foreground scans will be triggered according to the determined cadence).

Thereafter, at or near the end of time interval 2 (e.g., right before entering time interval 4), the current progress of scanned blocks (e.g., how many of the total number of blocks have been scanned thus far) is redetermined or re-checked and the current progress is compared against an expected progress for time interval 2. Again, if at or near the end of time interval two, the number of scanned blocks is ≥20% of the total blocks to be scanned (at the start of the schedule 400), then foreground scans are disabled (e.g., skipped) at least for time interval 4. However, if at or near the end of time interval 2 the number of scanned blocks is not ≥20% of the total blocks to be scanned (at the start of the schedule 400), then a cadence is determined based on a difference between the number of blocks scanned thus far and 20% of the total blocks to be scanned (e.g., cadence determined based on a difference look-up-table), and foreground scans are enabled at least for time interval 3 with the determined cadence (foreground scans will be triggered according to the determined cadence). This continues for each of time intervals 4 through 8 of the schedule 400. As shown, the cadence of the foreground scans remain at 16 seconds until 440, changes to 8 seconds at 450 (based on comparison of current progress and expected progress), remains at 8 seconds until 480, and eventually changes to 4 seconds at 490.

Eventually, at or near the end of time interval 9 (e.g., right before entering time interval 10), it is determined whether all blocks (to be scanned) have been scanned (490). If yes, then both background scans and foreground scans are disabled for time interval 10 (which represents the last time interval). If no, both background scans and foreground scans are enabled at least for time interval 10, and the foreground scans can be enabled with a fastest available cadence (e.g., cadence of 4 seconds).

Referring now to the schedule 500 of FIG. 5, the schedule 500 comprises a time period 504 (e.g., one cycle period T) having a time span of 30 units of time. As described herein, each unit of time (time unit) can be any measure of time, such as an hour, minute, or seconds. As shown, the time period 504 (e.g., T) is non-uniformly divided by a value N=4, thereby dividing the time period into 4 consecutive sections (or time intervals) and resulting in a series of time intervals (502) 1 through 4. As shown, time intervals 1 and 4 have similar time spans (of 3 time units), while timer intervals 2 and 3 have similar time spans (of 12 time units). The division of the time period 504 can be divided into non-uniform time intervals by a process that results in a random number of time units being included in one or more of the time intervals. During time interval 1 (506), foreground scans are disabled (e.g., skipped) and only background scans are enabled. After time interval 1 (506), foreground scans can be dynamically enabled and disabled for one or more of time intervals 2 through 4 (508). At or near the end of time interval 1 (e.g., right before entering time interval 2), the current progress of scanned blocks (e.g., how many of the total number of blocks have been scanned thus far) is determined or checked and the current progress is compared against an expected progress (510) for time interval 1. For some embodiment, if the current progress (number of scanned blocks thus far) is less than the expected progress, then foreground scans are enabled at least for time interval 2. If, however, at least equal to or greater than the expected progress, then foreground scans can be enabled at least for time interval 2. For various embodiments (e.g., where time intervals are non-uniform), the expected progress at or near the end of a time interval K is ≥(L*100) % of the total blocks to be scanned (at the start of the schedule 500), where L is determined by dividing the number of time units between the start of the schedule 500 and the end of time interval K by total number of time units (e.g., 30 time units) of the schedule 500. Accordingly, if at or near the end of time interval 1 the number of scanned blocks is ≥10% of the total blocks to be scanned (based on (3 time units/30 time units)*100), then foreground scans are disabled (e.g., skipped) at least for time interval 2. However, if at or near the end of time interval 1 the number of scanned blocks is not ≥10% of the total blocks to be scanned (at the start of the schedule 500), then a cadence is determined using a formula based on number of time units remaining in the time period 504 and the number of blocks that remain to be scanned, and foreground scans are enabled at least for time interval 2 with the determined cadence. For some embodiments, the cadence formula comprises: number of time units remaining in time period*(a rate of blocks scanned per a sub-time unit/total number of unscanned blocks remaining). For instance, at or near the time interval 1 where 27 hours remain in the time period 504, if 13,360 blocks remain unscanned, and the rate of blocks scanned per a second is 3600 blocks, the determined (e.g., calculated) cadence can comprise: 27×3600/13360=7 s.

Thereafter, at or near the end of time interval 2 (e.g., right before entering time interval 5), the current progress of scanned blocks (e.g., how many of the total number of blocks have been scanned thus far) is redetermined or re-checked and the current progress is compared against an expected progress (520) for time interval 2. Again, if at or near the end of time interval two, the number of scanned blocks is ≥50% of the total blocks to be scanned (based on (15 time units/30 time units)*100), then foreground scans are disabled (e.g., skipped) at least for time interval 3. However, if at or near the end of time interval 2 the number of scanned blocks is not ≥50% of the total blocks to be scanned, then a cadence is determined based on the formula (e.g., number of time units remaining in time period*(a rate of blocks scanned per a sub-time unit/total number of unscanned blocks remaining)). For instance, at or near the time interval 2 where 15 hours remain in the time period 504, if 6,160 blocks remain unscanned, and the rate of blocks scanned per a second is 3600 blocks, the determined (e.g., calculated) cadence can comprise: 15×3600/6160=8.76 s. This repeats for time interval 3 of the schedule 500.

Eventually, at or near the end of time interval 3 (e.g., right before entering time interval 4), it is determined whether all blocks (to be scanned) have been scanned (530). If yes, then both background scans and foreground scans are disabled for time interval 4 (which represents the last time interval). If no, both background scans and foreground scans are enabled at least for time interval 3, and the foreground scans can be enabled with a cadence determined based on the formula (e.g., number of time units remaining in time period*(a rate of blocks scanned per a sub-time unit/total number of unscanned blocks remaining)).

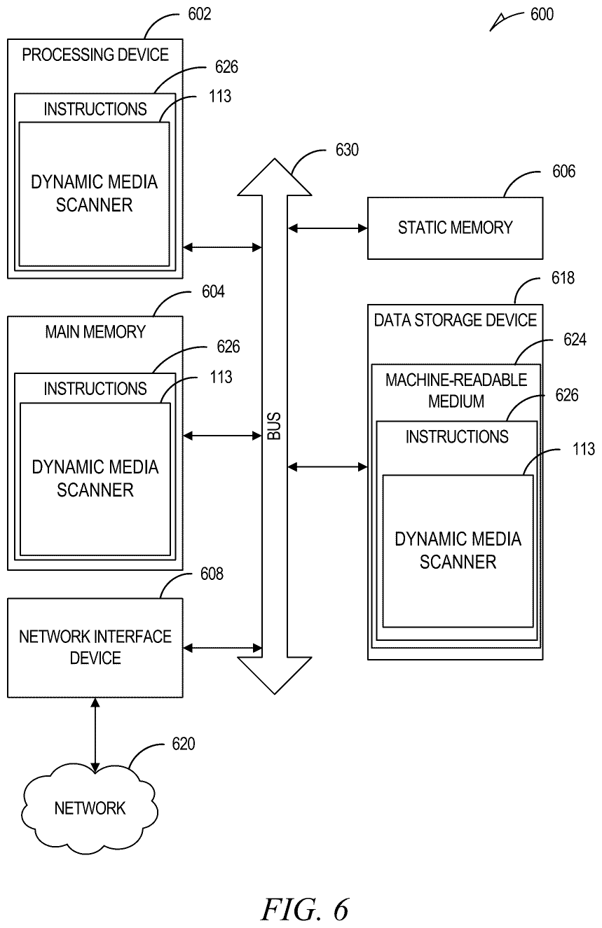

FIG. 6 illustrates an example machine in the form of a computer system 600 within which a set of instructions can be executed for causing the machine to perform any one or more of the methodologies discussed herein. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., ROM, flash memory, DRAM such as SDRAM or Rambus DRAM (RDRAM), etc.), a static memory 606 (e.g., flash memory, static random access memory (SRAM), etc.), and a data storage device 618, which communicate with each other via a bus 630.

The processing device 602 represents one or more general-purpose processing devices such as a microprocessor, a central processing unit, or the like. More particularly, the processing device 602 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 602 can also be one or more special-purpose processing devices such as an application-specific integrated circuit (ASIC), a field programmable gate array (FPGA), a digital signal processor (DSP), a network processor, or the like. The processing device 602 is configured to execute instructions 626 for performing the operations and steps discussed herein. The computer system 600 can further include a network interface device 608 to communicate over a network 620.

The data storage device 618 can include a machine-readable storage medium 624 (also known as a computer-readable medium) on which is stored one or more sets of instructions 626 or software embodying any one or more of the methodologies or functions described herein. For some embodiments, the machine-readable storage medium 624 is a non-transitory machine-readable storage medium. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage device 618, and/or main memory 604 can correspond to the memory sub-system 110 of FIG. 1.

In one embodiment, the instructions 626 include instructions to implement functionality corresponding to dynamically enabling and disabling foreground scans of blocks of a memory device as described herein (e.g., the dynamic media scanner 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (e.g., non-transitory machine-readable medium) having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, and so forth.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled to the memory device, configured to perform operations comprising:
determining a schedule for scanning a plurality of blocks of the memory device, the schedule comprising a time period that is divided into a series of time intervals;
causing background scans to be enabled for scanning the plurality of blocks;
causing foreground scans to be disabled for scanning the plurality of blocks for at least a first time interval of the time period; and
prior to an end of the first time interval:
determining a number of scanned blocks in the plurality of blocks since a beginning of the first time interval;
determining, based on the number of scanned blocks and an expected scan progress at the end of the first time interval, whether to enable foreground scans for scanning any remaining unscanned blocks of the plurality of blocks for at least a second time interval of the time period; and
in response to determining that the foreground scans should be enabled for scanning any remaining unscanned blocks of the plurality of blocks for at least the second time interval, causing the foreground scans to be enabled for at least the second time interval.

2. The system of claim 1, wherein the causing of the foreground scans to be enabled for at least the second time interval comprises enabling the foreground scans to be performed with a fixed scan cadence during the second time interval.

3. The system of claim 1, wherein the causing of the foreground scans to be enabled for at least the second time interval comprises:
determining a difference between the number of scanned blocks and the expected scan progress at the end of the first time interval;
determining a scan cadence based on the difference; and
enabling the foreground scans to be performed with the scan cadence during the second time interval.

4. The system of claim 3, wherein the determining of the scan cadence based on the difference comprises:
identifying the scan cadence in a predetermined look-up table based on the difference.

5. The system of claim 3, wherein the determining of the scan cadence based on the difference comprises:
calculating the scan cadence based on the difference and a cadence formula.

6. The system of claim 1, wherein the operations comprise:
during a second time interval of the time period and prior to an end of the second time interval:
redetermining the number of scanned blocks in the plurality of blocks since the beginning of the first time interval;
determining, based on the number of scanned blocks and the expected scan progress at the end of the second time interval, whether to enable foreground scans for scanning any remaining unscanned blocks of the plurality of blocks for at least a third time interval of the time period;
in response to determining that the foreground scans should be enabled for scanning any remaining unscanned blocks of the plurality of blocks for at least the third time interval, causing the foreground scans to be enabled for at least the third time interval; and
in response to determining that the foreground scans should not be enabled for scanning any remaining unscanned blocks of the plurality of blocks for at least the third time interval, causing the foreground scans to be disabled for at least the third time interval.

7. The system of claim 6, wherein the causing of the foreground scans to be enabled for at least the third time interval comprises:
determining a difference between the number of scanned blocks and the expected scan progress at the end of the second time interval;
determining a scan cadence based on the difference; and
enabling the foreground scans to be performed with the scan cadence during the third time interval.

8. The system of claim 7, wherein the determining of the scan cadence based on the difference comprises:
identifying the scan cadence in a predetermined look-up table based on the difference.

9. The system of claim 7, wherein the determining of the scan cadence based on the difference comprises:
calculating the scan cadence based on the difference and a cadence formula.

10. The system of claim 1, wherein the series of time intervals comprises N number of time intervals, and wherein the operations comprise:
during an (N-1)th time interval of the time period and prior to the end of the (N-1)th time interval:
redetermining the number of scanned blocks in the plurality of blocks since the beginning of the first time interval;
determining, based on the number of scanned blocks, whether all blocks of the plurality of blocks have been scanned; and
in response to determining that all blocks of the plurality of blocks have been scanned:
causing the background scans to be disabled for an Nth time interval of the time period; and
causing the foreground scans to be disabled for the Nth time interval.

11. The system of claim 1, wherein the series of time intervals comprises N number of time intervals, and wherein the operations comprise:
during an (N-1)th time interval of the time period and prior to the end of the (N-1)th time interval:
redetermining the number of scanned blocks in the plurality of blocks since the beginning of the first time interval;
determining, based on the number of scanned blocks, whether all blocks of the plurality of blocks have been scanned; and
in response to determining that not all blocks of the plurality of blocks have been scanned, causing the foreground scans to be enabled for an Nth time interval.

12. The system of claim 1, wherein each time interval of the series of time intervals has a uniform time span.

13. The system of claim 1, wherein at least two time intervals of the series of time intervals have a different time span.

14. The system of claim 1, wherein the time period defines a time over which the scanning of all blocks of the plurality of blocks is to be completed.

15. The system of claim 1, wherein the determining of the schedule comprises:
determining the series of time intervals by uniformly dividing the time period into the series of time intervals such that each time interval of the series of time intervals has a uniform time span.

16. The system of claim 1, wherein the determining of the schedule comprises:
determining the series of time intervals by non-uniformly dividing the time period into the series of time intervals such that the series of time intervals comprises at least two time intervals having a different time span.

17. At least one non-transitory machine-readable storage medium comprising instructions that, when executed by a processing device of a memory sub-system, cause the processing device to perform operations comprising:
determining a schedule for scanning a plurality of blocks of a memory device of the memory sub-system, the schedule comprising a time period that is divided into a series of time intervals;
causing background scans to be enabled for scanning the plurality of blocks;
causing foreground scans to be disabled for scanning the plurality of blocks for at least a first time interval of the time period; and
prior to an end of the first time interval:
determining a number of scanned blocks in the plurality of blocks since a beginning of the first time interval;
determining, based on the number of scanned blocks and an expected scan progress at the end of the first time interval, whether to enable foreground scans for scanning any remaining unscanned blocks of the plurality of blocks for at least a second time interval of the time period; and
in response to determining that the foreground scans should be enabled for scanning any remaining unscanned blocks of the plurality of blocks for at least the second time interval, causing the foreground scans to be enabled for at least the second time interval.

18. The at least one non-transitory machine-readable storage medium of claim 17, wherein the causing of the foreground scans to be enabled for at least the second time interval comprises:
determining a difference between the number of scanned blocks and the expected scan progress at the end of the first time interval;
determining a scan cadence based on the difference; and
enabling the foreground scans to be performed with the scan cadence during the second time interval.

19. The at least one non-transitory machine-readable storage medium of claim 17, wherein the operations comprise:
during a second time interval of the time period and prior to an end of the second time interval:
redetermining the number of scanned blocks in the plurality of blocks since the beginning of the first time interval;
determining, based on the number of scanned blocks and the expected scan progress at the end of the second time interval, whether to enable foreground scans for scanning any remaining unscanned blocks of the plurality of blocks for at least a third time interval of the time period;
in response to determining that the foreground scans should be enabled for scanning any remaining unscanned blocks of the plurality of blocks for at least the third time interval, causing the foreground scans to be enabled for at least the third time interval; and
in response to determining that the foreground scans should not be enabled for scanning any remaining unscanned blocks of the plurality of blocks for at least the third time interval, causing the foreground scans to be disabled for at least the third time interval.

20. A method comprising:
determining, by a processing device of a memory sub-system, a schedule for scanning a plurality of blocks of a memory device of the memory sub-system, the schedule comprising a time period that is divided into a series of time intervals;
causing, by the processing device, background scans to be enabled for scanning the plurality of blocks;
causing, by the processing device, foreground scans to be disabled for scanning the plurality of blocks for at least a first time interval of the time period; and
prior to an end of the first time interval:
determining, by the processing device, a number of scanned blocks in the plurality of blocks since a beginning of the first time interval;
determining, by the processing device and based on the number of scanned blocks and an expected scan progress at the end of the first time interval, whether to enable foreground scans for scanning any remaining unscanned blocks of the plurality of blocks for at least a second time interval of the time period; and
in response to determining that the foreground scans should be enabled for scanning any remaining unscanned blocks of the plurality of blocks for at least the second time interval, causing, by the processing device, the foreground scans to be enabled for at least the second time interval.
